(19) United States
(12) Patent Application Publication
(10) Pub. No.: US 2013/0337837 A1
(43) Pub. Date: Dec. 19, 2013

(54) PHYSICAL ACTIVITY-BASED SERVICES

(71) Applicant: Alison Burdett, Oxford (GB)

(72) Inventor: Alison Burdett, Oxford (GB)

(73) Assignee: Toumaz Healthcare Limited, Oxfordshire (GB)

(21) Appl. No.: 13/524,359

(22) Filed: Jun. 15, 2012

(51) Int. Cl. H04W 4/12; H04W 64/00

(52) U.S. Cl. 455/456.3

(57) ABSTRACT

The invention relates to an apparatus and a method of selecting a message to be sent to a user. The message is selected according to an activity which is undertaken by the user. The activity is determined using physical parameters of the user measured by a monitor attached to the user and transmitted to a third party. Optionally, the message may also be selected using the location of the user.

### TECHNICAL FIELD

The present invention relates to a method and apparatus for selecting a message for a user dependent upon the activity of the user. It is preferably, although not necessarily limited to, use for targeting advertising to a user.

### BACKGROUND

Location-based services are becoming of increasing importance. Location-based services are services which are delivered to a particular user based on knowing the spatial location of that user. For example, the user may carry a cellular telephone which contains a GPS receiver. The physical location of the user, as determined by the GPS receiver, is transmitted via the telephone back to a network. The network identifies the services on offer to users in that location and provides messages back to the user. This information could be environmental (e.g. traffic or weather information), but increasingly the information is likely to be advertising services for local businesses.

Whilst it is useful to identify customers according to their location, for example, to advertise a shop to users present within a nearby location, advertisers will increasingly wish to target the advertising of their products and services to users who are inherently interested in their specific type of product or service.

### SUMMARY

According to the present invention there is provided a method of selecting a message to be transmitted to a user. The message being selected by: deriving an activity of a user from one or more physical parameters of the user; selecting a message using the derived activity; and transmitting the message to the user. By selecting a message using an activity which it has been determined the user is carrying out the contents of messages can be more specifically targeted to the types of activities the user likes to carry out.

The method may also include the step of determining a location of the user. The location of the user may therefore be used when selecting the message. This means that the contents of the message are not only targeted according to the activity of the user but also according to the user's location. This may enable a person to receive vouchers relating to their activity from nearby stores or information relating to clubs or services in their location.

A server may receive the one or more physical parameters and derive the activity. This means that minimal changes and customisation need to be made to the user's devices such as the cellular telephone or the monitor.

The message may be transmitted to an email account associated with the user or a telephone number associated with the user. In this way the user can select to receive messages in the format which best suits them. It should be noted that by being able to receive messages at any account the user may be able to retrieve the message at any time on any suitable device. For example, the user may retrieve the message using a cellular telephone, a personal computer, a laptop or a tablet computer.

The message may be transmitted by email, SMS message, MMS message or any other suitable means.

The message may include a discount, a voucher or information relating to the determined activity.

According to another aspect of the present invention there is provided a device. The device includes an input to receive a physical parameter of a user, a processor configured to derive the activity of the user from the physical parameter and select a message to be sent to the user using the derived activity and an output to transmit the message. By selecting a message using an activity the user is carrying out the contents of messages can be more specifically targeted to the types of activities the user likes to carry out.

The device may also receive a location of the user. In such a case the processor will select the message using the derived activity and the location. Alternatively, the device may include an input to receive location information for the user, a further processor to determine the location of the user from the location information, wherein the processor selects the message using the derived activity and the location. This allows the message to be targeted not only towards the activity being undertaken by the user but also the user's location.

The message may be transmitted to an email account associated with the user or a telephone number associated with the user. In this way the user can select to receive messages in the format which best suits them. It should be noted that by being able to receive messages at any account the user may be able to retrieve the message at any time on any suitable device. For example, the user may retrieve the message using a cellular telephone, a personal computer, a laptop or a tablet computer.

The message may be transmitted by email, SMS message, MMS message or any other suitable means.

The message may include a discount, a voucher or information relating to the determined activity.

### BRIEF DESCRIPTION OF THE DRAWINGS

FIG. 1 is a system which may implement the invention; and

FIG. 2 is a diagram of a network implementing an alternative embodiment of the invention.

### DETAILED DESCRIPTION

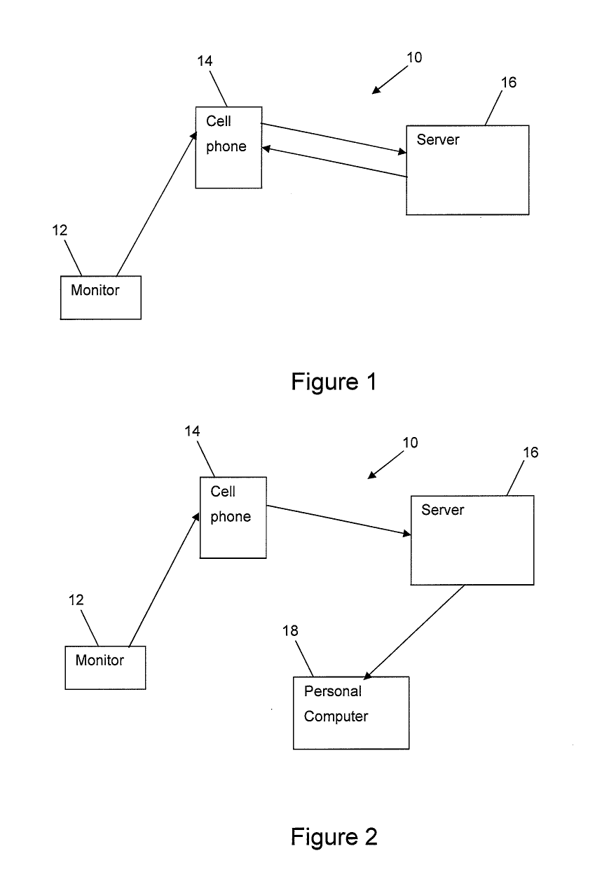

A system 10 for monitoring user activity and providing feedback is illustrated in FIG. 1. The system 10 includes a monitor 12 which can be attached to a user's body to measure physical and biomechanical data, such as one or more of heart rate, physical activity energy expenditure, physical activity intensity, for with the user. For example, the monitor may include one or more of a heart rate monitor, an accelerometer or a gyroscope. The data collected by the monitor is transmitted to a cellular telephone 14 worn on the user's body which relays the information to a server 16.

Upon receiving the physical and biomechanical data the server 12 determines the activity being undertaken by the user using any suitable method. For example the activity may be determined using algorithms including neural networks or branched equation models. An example of a method of determining user activity is described in US 2008/0275348. The activity may be, for example, running, tennis, cycling or walking.

The server 16 includes a memory storing a number of messages. The messages include information relating to at least one activity. The server 16, upon determining the activity of the user will select a message including information relating to the activity of the user and transmit the message to a user device associated with the user. For example, if the user is running then the device may select a message including a voucher for running clothes and transmit the message to the cellular telephone.

In an alternative embodiment of the invention illustrated in FIG. 2, the server will receive the physical and biomechanical data as described with reference to FIG. 1. The server 16 then selects the message as described above and transmits the message to the user's email account. The user can then access the message at their personal computer 18 at a later date.

The user may be registered at the server in order to receive the messages. When the user registers at the server they may select in which format they wish to receive messages about services. For example, they may select to receive messages in the form of an email, an SMS message, an MMS message or any other suitable format.

Optionally, the server may determine the frequency that the user undertakes the activity in order to further target the messages transmitted to the user device. For example, if the user cycles often (or more than a threshold number of times in a week, month or year) then the server may send details about cycling holidays or cycling groups to the user.

Optionally, the server may be configured to receive further data. For example, the cellular telephone may include means, such as a GPS receiver to determine the location of the user. Location data indicating the location of the user may be transmitted to the server at the same time as the physical and biomechanical data. The server may use the location data to determine relevant details for the activity in that location. For example, the server may determine the identities of cycling groups which meet within a 5 mile radius of the location of the user. Or, if the location is not the user's usual location the server may transmit information relating to cycling routes in the area.

Alternatively, the monitor may include means for determining the location of the user and transmit location data to the cellular telephone at the same time as the physical and biomechanical data. The cellular telephone can then relay the location data and physical and biomechanical data to the server.

Although the present invention has been described with reference to a cellular telephone, data may also be transmitted directly to the server by the monitor or, alternatively, through any other suitable intermediate device. For example, data may be transmitted by the monitor to an intermediate device which includes a GSM chipset which, upon receiving data from the monitor transfers it to the server over a wireless interface. Alternatively, the intermediate device may be provided with a WiFi interface for communicating with the server.

Optionally, the user's monitor, or intermediate device may be arranged to determine the activity of the user and transmit the activity information to the server. The server may then select the message as described above.

Optionally, the monitor may be provided with a memory. The memory stores the measured physical and biomechanical data and, if it is measured, location data as it is determined by the monitor. The monitor can then transmit the physical and biomechanical data, and where appropriate location data, when it determines the presence of the intermediate device (for example when an intermediate device responds to a transmission from the monitor). This provides an advantage that the user only has to carry the monitor when they are performing the physical exercise and does not have to carry a second device to transmit data to a server in real-time.

Preferably the monitor is a monitor worn by the user to track their physical activity status as part of a health and fitness regime. For example, it may be a heart rate monitor.

The server may comprise a single device or may be distributed across several devices. For example, the memory including the messages may be housed on a different device to the part of the server determining the activity of the user.

By providing feedback in such a manner the user may be alerted to useful information without having to search for it themselves.

1. A method comprising the steps of:
deriving a type of activity of a user from one or more physical parameters of the user;
selecting a message using the derived type of activity; and
transmitting the message to the user;
wherein the message includes content relating to the derived type of activity.

2. The method claimed in claim 1 further comprising determining a location of the user and the step of selecting a message comprises selecting the message using the derived activity and the determined location.

3. The method claimed in claim 1 further comprising a server receiving said one or more physical parameters wherein said server performs the step of deriving an activity.

4. A method as claimed in claim 1 wherein transmitting the message comprises transmitting the message to an email account associated with the user or a telephone number associated with the user.

5. A method as claimed in claim 1 wherein transmitting the message comprises transmitting an email, an SMS message or an MMS message.

6. A method as claimed in claim 1 wherein the message includes at least one of: a discount, a voucher and information relating to the determined activity.

7. Apparatus comprising:
an input to receive a physical parameter of a user;
a processor configured to derive a type of activity of the user from the physical parameter and select a message to be sent to the user using the derived type of activity; and
an output to transmit the message;
wherein the message includes content relting to the derived type of activity.

8. The apparatus claimed in claim 7 further comprising an input to receive a location of the user wherein the processor selects the message using the derived activity and the location.

9. The apparatus claimed in claim 7 further comprising an input to receive location information for the user, a further processor to determine the location of the user from the location information, wherein the processor selects the message using the derived activity and the location.

10. The apparatus claimed in claim 7 wherein transmitting the message comprises transmitting the message to an email account associated with the user or a telephone number associated with the user.

11. The apparatus claimed in claim 7 wherein transmitting the message comprises transmitting an email, an SMS message or an MMS message.

12. The apparatus claimed in claim 7 wherein the message includes at least one of: a discount, a voucher and information relating to the determined activity.
